(19) United States
(12) Patent Application Publication
(10) Pub. No.: US 2012/0235523 A1
(43) Pub. Date: Sep. 20, 2012

(54) BUS BAR MODULE FOR AN ELECTRIC MACHINE

(75) Inventors: Hector Luis Moya, Austin, TX (US); David Christopher Baker, Austin, TX (US); Ramon Anthony Caamaño, Gilroy, CA (US)

(73) Assignee: GREEN RAY TECHNOLOGIES LLC, Gilroy, CA (US)

(21) Appl. No.: 13/394,911

(22) PCT Filed: Sep. 7, 2010
(86) PCT No.: PCT/US10/48027

§ 371 Date: May 25, 2012

Related U.S. Application Data
(60) Provisional application No. 61/240,492, filed on Sep. 8, 2009.
(60) Provisional application No. 61/240,501, filed on Sep. 8, 2009.

(51) Int. Cl. H02K 3/28

(52) U.S. Cl. 310/71

(57) ABSTRACT

In some implementations, the present disclosure provides an electric machine including a rotor assembly, a stator assembly comprising a plurality of stator modules, each stator comprising multiple, independently energizeable stator segments, each segment having a corresponding electrical connecting point, and a plurality of bus bars connected to the electrical connecting points of the stator assembly, each bus bar corresponding to a different phase of the machine and electrically connecting segments of multiple stator modules. The stator modules and their electrical connecting points are arranged such that spacing between adjacent connecting points within each stator module differs from spacing between adjacent connecting points of different modules.

### SUMMARY

In some aspects, the present disclosure provides an electric machine including a rotor assembly, and a stator assembly having a plurality of stator modules, each stator comprising multiple, independently energizeable stator segments, each segment having a corresponding electrical connecting point. A plurality of bus bars are connected to the electrical connecting points of the stator assembly, each bus bar corresponding to a different phase of the machine and electrically connecting segments of multiple stator modules. The stator modules and their electrical connecting points are arranged such that spacing between adjacent connecting points within each stator module differs from spacing between adjacent connecting points of different modules.

In some aspects, the stator assembly is disposed within the rotor assembly, the stator assembly and rotor assembly defining therebetween an active magnetic radial gap.

In some aspects, the bus bars are provided in a nested arrangement.

In some aspects, arms of one of the bus bars extend transverse to another of the bus bars.

In some aspects, at least one of the bus bars includes a segment that passes over, and is spaced from, arms of at least another of the bus bars. In some aspects, the segment is spaced from the arms a distance sufficient to inhibit arcing.

In some aspects, each bus bar includes a plurality of generally L-shaped arms having a first segment and a second segment perpendicular to the first segment.

In some aspects, each bus bar includes a plurality of arms, each arm defining a bore configured to receive a fastener to secure the arm to a respective stator module of the electric machine.

In some aspects, the bus bars are concentrically arranged relative to one another.

In some aspects, each of the bus bars includes arms extending radially outward.

In some aspects, arms of one of the bus bars are longer than arms of another of the bus bars.

In some aspects, each of the bus bars is electrically conductive.

In some aspects, a radial distance between adjacent bus bars varies. In some aspects, an insulator segment that is disposed between adjacent bus bars in a region, within which region the radial distance is at a minimum. In some aspects, the insulator segment is discontinuous about a diameter. In some aspects, an insulator segment is absent from between adjacent bus bars in a region, within which region the radial distance is at a maximum.

In some aspects, an insulator that receives each of the bus bars. In some aspects, the insulator includes a plurality of radial grooves for receiving each of the arms of the bus bars. In some aspects, the radial grooves define a plurality of sets of grooves, adjacent grooves in a set of grooves defining an angular spacing, and the sets of the plurality of sets of grooves being offset from one another, different angular spacing. In some aspects, the insulator is electrically non-conductive. In some aspects, the insulator comprises a plurality of lands that can support one or more of the bus bars. In some aspects, the insulator comprises a plurality of bores, through which a fastener can pass to secure a bus bar to a respective stator module. In some aspects, the insulator comprises a plurality of protrusions for indexing the bus bar assembly relative within the electric machine.

In some aspects, the electric machine is a three-phase electric machine, and there are three bus bars.

In some aspects, the electric machine comprises four stator modules.

In some aspects, the electric machine comprises six stator modules.

In some aspects, the stator modules are individually removable, and the machine is operable with multiple configurations of stator modules.

In some aspects, each of the plurality of stator segments is an independently energizable electromagnetic assembly, and comprises a one-piece magnetic core defining two stator poles located at opposite ends of the one-piece magnetic core. In some aspects, the one-piece magnetic core is formed from thin film soft magnetic material. In some aspects, the one-piece magnetic core is formed from a powdered magnetic material.

In some aspects, multiple stator segments within a stator module correspond to a common phase.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 is a schematic illustration of an exemplar electric machine including an exemplar bus bar module in accordance with aspects of the present disclosure.

FIG. 2A is a plan view of the exemplar bus bar module of FIG. 1.

FIG. 2B is a perspective view of the exemplar bus bar module of FIG. 1.

FIG. 2C is an exploded view of the exemplar bus bar module of FIG. 1.

FIGS. 3A and 3B illustrate an exemplar bus ring insulator of the exemplar bus bar module of FIGS. 1 to 2C.

FIGS. 4A-4C illustrate an exemplar first bus ring of the exemplar bus bar module of FIGS. 1 to 2C.

FIGS. 5A-5C illustrate an exemplar second bus ring of the exemplar bus bar module of FIGS. 1 to 2C.

FIGS. 6A-6C illustrate an exemplar third bus ring of the exemplar bus bar module of FIGS. 1 to 2C.

FIG. 7 is a schematic illustration of an exemplar electric machine including misaligned phases.

FIG. 8 is a schematic illustration of an exemplar electric machine including a stator assembly phase-shift in accordance with aspects of the present disclosure.

FIG. 9 is a plan view of another exemplar bus bar module including a phase-shift arrangement in accordance with aspects of the present disclosure.

FIG. 10 is an exploded view of the exemplar bus bar module of FIG. 9.

FIGS. 11A-11C illustrate bus rings of the exemplar bus bar module of FIGS. 9 and 10.

FIG. 12 is a schematic illustration of another exemplar electric machine including a stator assembly phase-shift in accordance with aspects of the present disclosure.

FIG. 13 is a schematic illustration of a portion of the exemplar electric machine of FIG. 12 including the exemplar bus bar module of FIGS. 9 and 10.

Like reference symbols in the various drawings indicate like elements.

### DETAILED DESCRIPTION

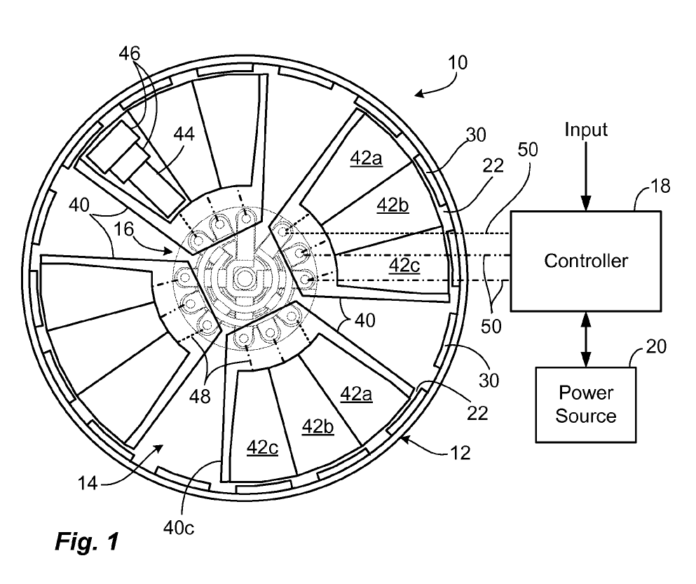

Referring now to FIG. 1, an exemplar electric machine 10 is illustrated. The electric machine 10 can include, but is not limited to, an electric motor and/or an electric generator. The electric machine 10 includes a rotor assembly 12, a stator assembly 14, a bus bar module 16, and a controller 18. The controller 18 regulates operation of the electric machine 10 based on an input signal. The input signal can include a throttle signal, for example, in the case where the electric machine 10 is implemented in a vehicle, motorcycle, scooter, or the like. The controller 18 can regulate power provided to the electric machine 10 from a power source 20, when the electric machine 10 is operating in a motor mode. The electric machine 10 can generate power that can be provided to, and stored in the power source 20, when the electric machine 10 is operating in a generator mode.

Although the electric machine 10 can be provided as a DC brushless motor, it is contemplated that the electric machine 10 can be provided as one of a variety of other types of electric machines within the scope of the present disclosure. Such electric machines include, but are not limited to, DC synchronous electric machines, variable reluctance or switched reluctance electric machines, and induction type electric machines. For example, permanent magnets can be implemented as the rotor poles of the electric machine 10, in the case where the electric machine 10 is provided as a DC brushless electric machine, as discussed in further detail below. In the case of a switched reluctance electric machine, or an induction electric machine, the rotor poles can be provided as protrusions of other magnetic materials formed from laminations of materials such as iron or preferably thin film soft magnetic materials, for example. In other arrangements, the rotor poles can be provided as electromagnets.

In the exemplar arrangement of FIG. 1, the electric machine 10 is provided as a hub-type electric machine with rotor assembly 12 located around the outer perimeter of the electric machine 10. The stator assembly 14 is surrounded by the rotor assembly 12. Although not illustrated in FIG. 1, the rotor assembly 12 can be supported by bearings to rotate relative to the stator assembly 14. A radial gap 22 separates the rotor assembly 12 from the stator assembly 14. In alternative arrangements, the rotor assembly 12 can be supported for rotation relative to the stator assembly 14 using other suitable means.

The rotor assembly 10 includes a plurality of pairs of radially adjacent permanent magnets 30. In some implementations, the pairs of permanent magnets 30 can be provided as super magnets such as cobalt rare earth magnets, or any other suitable or readily providable magnet material. Although not illustrated in FIG. 1, each of the pairs of permanent magnets 30 includes a first magnet oriented to form a north rotor pole, and a second magnet oriented to form a south rotor pole. The first magnet is located adjacent to the second magnet such that the two permanent magnets are in line with one another along a line that is parallel with the rotational axis of the electric machine 10. Accordingly, the two permanent magnets define adjacent circular paths about the rotational axis of the electric machine 10 when the rotor assembly 12 rotates. As shown in FIG. 1, the permanent magnet pairs are positioned around the inside periphery of the rotor assembly 12 within the radial gap 22. Each consecutive pair of permanent magnets 30 is reversed such that all of the adjacent magnet segments alternate from north to south around the entire rotor assembly 12.

Although permanent magnet pairs 30 can be provided as permanent super magnets, other magnetic materials can be implemented. In some implementations, electromagnets can be implemented with the rotor assembly 12 in place of permanent magnets. Also, although the rotor assembly 12 of FIG. 1 is illustrated as including 16 magnet pairs, it is contemplated that the rotor assembly 12 can include any number of magnet pairs.

The stator assembly 14 includes a plurality of stator modules 40. In the exemplar arrangement of FIG. 1, the stator assembly 14 includes four stator modules 40. However, other arrangements are contemplated. For example, stator assemblies including more than four stator modules 40, or less than four stator modules 40 are within the scope of the present disclosure, as discussed in further detail below. Each stator module 40 includes at least one stator segment with each stator segment corresponding to a phase of the electric machine 10.

In the exemplar arrangement of FIG. 1, the exemplar electric machine 10 is provided as a 3-phase electric machine, and each stator module 40 includes three stator segments, a first stator segment 42a, a second stator segment 42b, and a third stator segment 42c. The first stator segment 42a of each of the stator modules 40 corresponds to a first phase (Phase A) of the electric machine 10, the second stator segment 42b of each of the stator modules 40 corresponds to a second phase (Phase B) of the electric machine 10, and the third stator segment 42c of each of the stator modules 40 corresponds to a third phase (Phase C) of the electric machine 10.

Each stator segment includes a core 44 and windings 46. In an exemplar implementation, the core 44 is a U-shaped magnetic core having windings 46, or coils, wound about each leg of the core 44. Such a stator segment is disclosed in U.S. Pat. Nos. 6,603,237, 6,879,080, 7,030,534, and 7,358,639, the disclosures of which are expressly incorporated herein by reference in their entireties.

In some implementations, the one-piece core can be made from a nano-crystalline, thin film soft magnetic material. In other implementations, any thin film soft magnetic material may be used, and can include, but are not limited to, materials generally referred to as amorphous metals, materials similar in elemental alloy composition to nano-crystalline materials that have been processed in some manner to further reduce the size of the crystalline structure of the material, and any other thin film materials having similar molecular structures to amorphous metal and nano-crystalline materials regardless of the specific processes that have been used to control the size and orientation of the molecular structure of the material.

In other implementations, the core can include a core that is made from a powdered metal. In other implementations, the core can be made from a plurality of stacked laminates. In still other implementations, the core can include a multi-piece core including a plurality of core segments that are assembled and secured together.

Each stator module 40 is independent from the other stator modules 40 in the stator assembly 14. More specifically, each stator module 40 is independently removable and replaceable. In some implementations, a stator module 40 can be removed, and the electric machine 10 can operate with less than a full complement of stator modules 40. Considering the specific arrangement of FIG. 1, for example, the electric machine 10 can operate with less than four stator modules 40 (e.g., the electric machine 10 can operate with one, two, or three stator modules 40).

When the electric machine 10 is operating in a motor mode, the stator segments 42a, 42b, 42c of each stator module 40 are selectively energizable by the controller 18 through the bus bar module 16. When the electric machine 10 is operating in a generator mode, energy can be generated by the electromagnetic interaction between the rotor assembly 12 and the stator modules 40, and transferred to the power source 20 through the bus bar module 16. To this end, the bus bar module 16 is in electrical communication with the windings of each of the stator segments 42a, 42b, 42c through electrical leads 48, each of which corresponds to a phase of the electric machine 10. The electrical leads 48 can be integrated within the stator modules 40, as discussed in further detail below. The bus bar module 16 is also in electrical communication with the controller 18 through electrical leads 50, each of which corresponds to a phase of the electric machine 10.

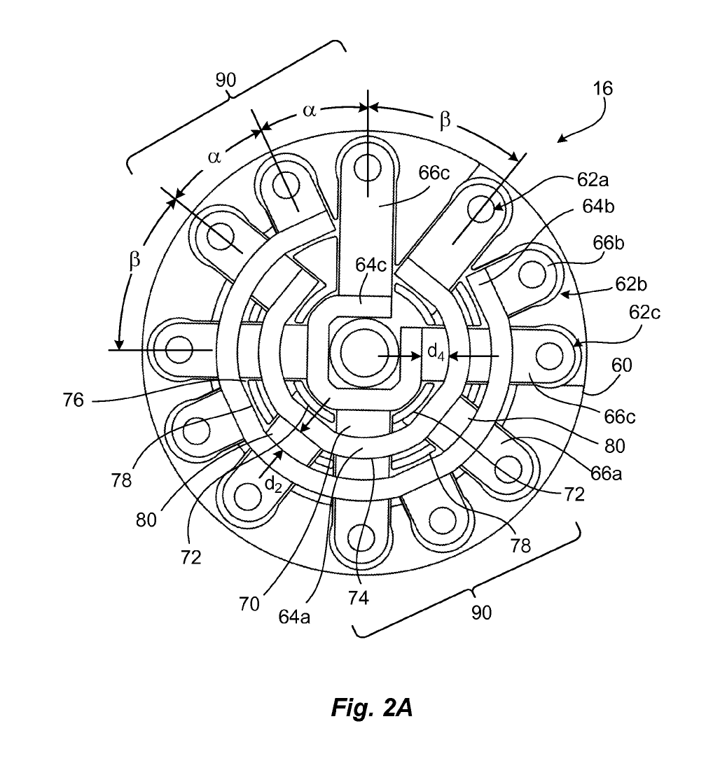

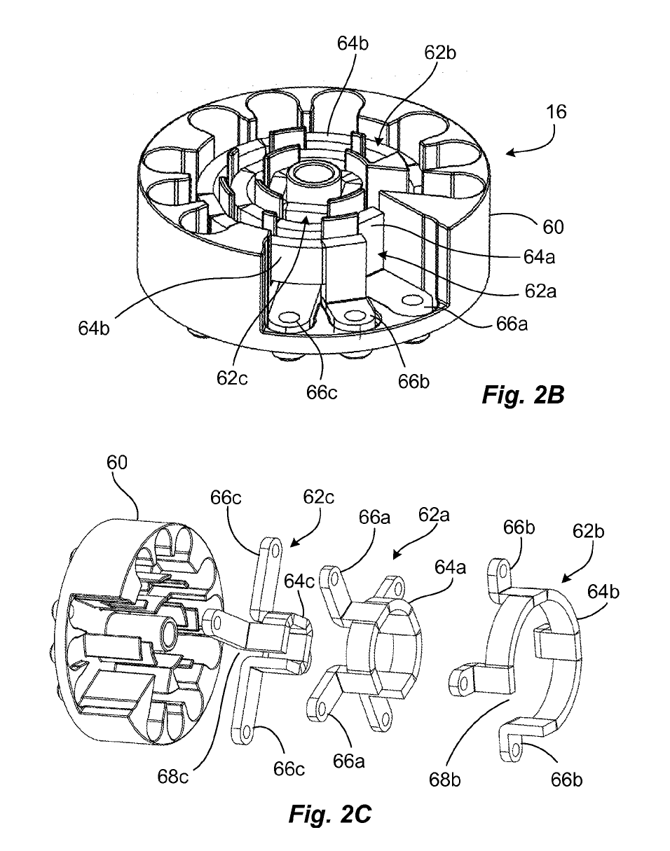

With particular reference to FIGS. 2A-2C, the exemplar bus bar module 16 includes an insulator 60, a bus bar 62a, a bus bar 62b, and a bus bar 62c. Each of the bus bars 62a, 62b, 62c corresponds to a phase of the electric machine 10. In the exemplar arrangement of FIG. 1, the bus bar 62a corresponds to the first phase (Phase A), the bus bar 62b corresponds to the second phase (Phase B), and the bus bar 62c corresponds to the third phase (Phase C). The bus bars 62a, 62b, 62c are concentrically arranged relative to one another, and are nested within the insulator 60, as discussed in further detail below.

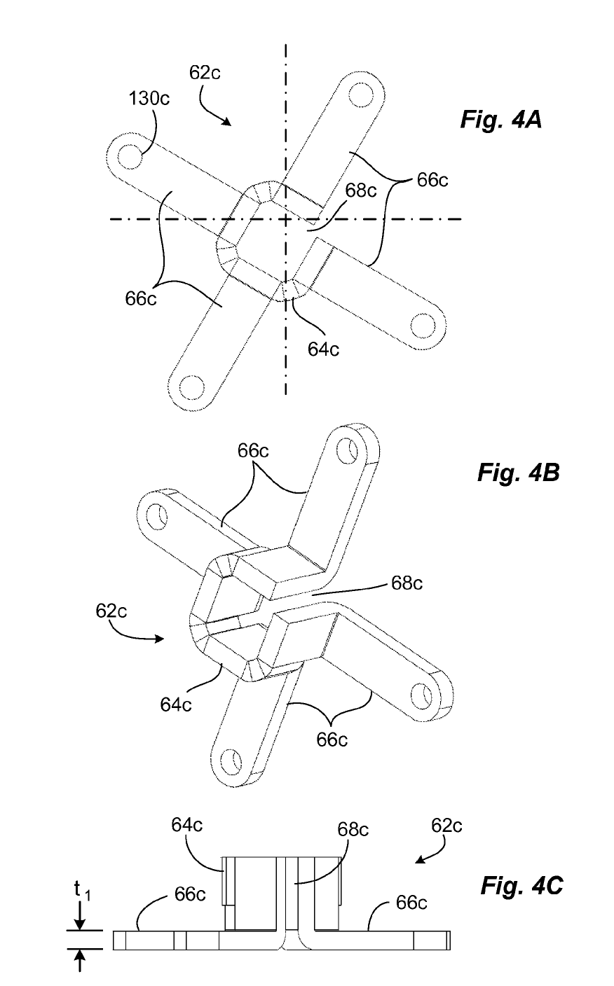

Each of the bus bars 62a, 62b, 62c includes a generally ring-shaped main body and a plurality of radially extending arms, and provides connecting points for connecting the bus bar to a stator module for electrical communication therebetween. More specifically, the bus bar 62a includes a main body 64a and a plurality of arms 66a, the bus bar 62b includes a main body 64b and a plurality of arms 66b, and the bus bar 62c includes a main body 64c and a plurality of arms 66c. In the exemplar arrangement of FIGS. 1 and 2A-2C, the main body of each bus bar is generally C-shaped having an opening 68a, 68b, 68c (see FIGS. 4A, 5A and 6A), and each bus bar includes four arms, corresponding to the four stator modules 40 of the exemplar electric machine 10. The bus bars 62a, 62b, 62c each define at least a portion of an electrical path between the controller 18 and the stator modules 40.

Each of the bus bars 62a, 62b, 62c is made from an electrically and thermally conductive material (e.g., copper, gold, platinum, electrically conductive non-metallic materials, and/or electrically conductive composite materials). Further, each of the bus bars 62a, 62b, 62c is exposed, not having an electrically and/or thermally insulating coating provided therearound. In this manner, each bus bar 62a, 62b, 62c can be manufactured from raw stock of a particular material, without further processing to insulate the bus bar. Each bus bar 62a, 62b, 62c can be manufactured from a single piece of material, or can be manufactured by assembling multiple components. For example, the main body of a bus bar can be provided as a separate component from the arms, and the arms can be secured to (e.g., through welding) the main body. As another example, a portion of each arm can define a portion of the main body, and the arms can be interconnected by a body component disposed therebetween.

The bus bars 62a, 62c are separated by a radial gap 70 having a distance d₁. The distance d₁ varies about the diameter of the radial gap 70 to provide a plurality of regions 72, in which the distance d₁ is at a minimum (d_{1MIN}), and a plurality of regions 74, in which the distance d₁ is at a maximum (d_{1MAX}). The bus bars 62a, 62b are separated by a radial gap 76 having a distance d₂. The distance d₂ varies about the diameter of the radial gap 76 to provide a plurality of regions 78, in which the distance d₂ is at a minimum (d_{2MIN}), and a plurality of regions 80, in which the distance d₂ is at a maximum (d_{2MAX}).

The bus bars 62a, 62b, 62c are assembled into the insulator 60, discussed in further detail below. The bus bar 62c is initially assembled into the insulator 60, and the bus bar 62b is subsequently assembled into the insulator 60 to be concentric with the bus bar 62c. The arms 66b, 66c of the bus bars 62b, 62c lie in a common plane, and the arms 66c of the bus bar 62c extend below the main body 64b of the bus bar 62b. In this manner, the bus bar 62c can be said to be nested within the bus bar 62b. The bus bar 62a is subsequently assembled into the insulator 60 to be concentric with the bus bars 62b, 62c. The arms 66a, 66b, 66c of the bus bars 62a, 62b, 62c lie in a common plane, and the arms 66b, 66c of the bus bars 62b, 62c extend below the main body 64a of the bus bar 62a. In this manner, the bus bars 62b, 62c can be said to be nested within the bus bar 62a.

The arms 66a, 66b, 66c of the bus bars 62a, 62b, 62c define a plurality of sets of arms 90. In the exemplar arrangement of FIGS. 1 and 2A-2C, four sets of arms 90 are provided, corresponding to the four stator modules 40 of the electric machine 10, and each set of arms 90 includes three arms 66a, 66b, 66c, corresponding to the exemplar phases of the electric machine 10. Adjacent arms 62a, 62b; 62b, 62c in a set of arms 90 define a first angle α. The sets of the plurality of sets of arms 90 are offset from one another by a second angle β, which is different than (i.e., not equal to) the first angle α. In the illustrated arrangement, α is greater than β. However, other arrangements are contemplated, in which α is less than β. Because α and β are not equal, improper connection of the stator modules 40 to the bus bar module 16 is prohibited, as discussed in further detail herein.

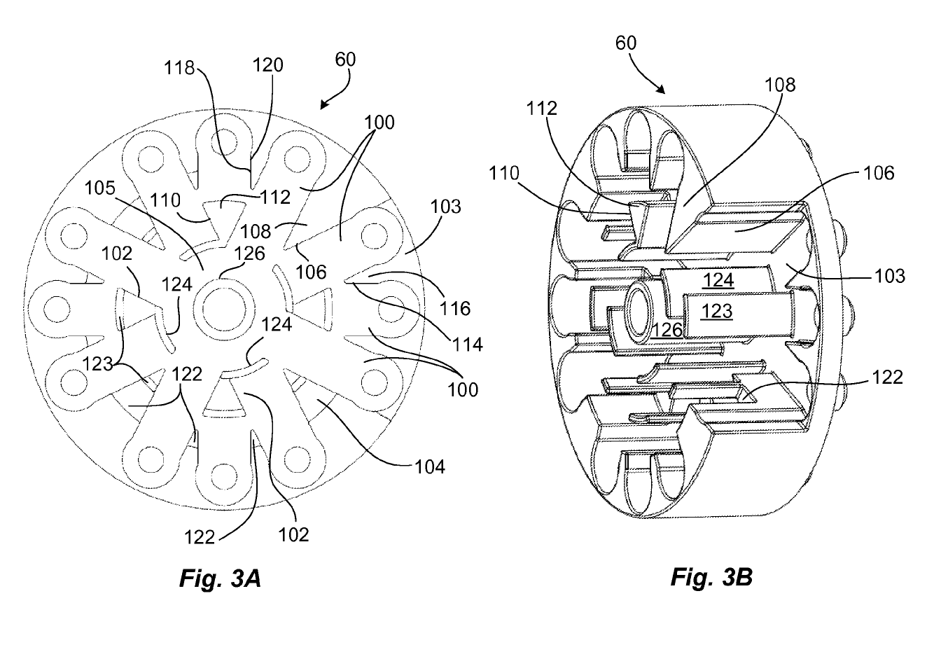

Referring now to FIGS. 3A and 3B, the insulator 60 includes a plurality of radially extending grooves 100, and a plurality of diametric grooves 102, 104, 105 crossing the radial grooves 100. The radial grooves receive and accommodate the arms 66a, 66b, 66c of the bus bars 62a, 62b, 62c, and the diametric grooves 102, 104, 105 receive and accommodate the main bodies 64a, 64b, 64c of the bus bars 62a, 62b, 62c, respectively. The insulator 60 also includes a wedge-shaped recess 103 extending to the periphery of the insulator 60. The recess 103 provides space for and accommodates the interconnection of the bus bars 62a, 62b, 62c to electrical leads (e.g., electrical leads 50) for connecting the bus bar module 16 to the controller 18.

The diametric groove 102 includes a stop 106 defined by a geometric feature 108 of the insulator 60, and a stop 110 defined by a geometric feature 112 of the insulator 60. The stops 106, 110 provide for indexing of the bus bar 62a as it is assembled into the diametric groove 102. More specifically, the geometric features 108, 110 extend into the opening 68a of the bus bar 62a to ensure that the bus bar 62a is properly assembled into the insulator 60. The diametric groove 102 further includes a plurality of lands 112 that can support the bus bar 62a. The diametric groove 104 includes a stop 114 defined by a geometric feature 116 of the insulator 60, and a stop 118 defined by a geometric feature 120 of the insulator 60. The stops 114, 118 provide for indexing of the bus bar 62b as it is assembled into the diametric groove 104. More specifically, the geometric features 116, 120 extend into the opening 68b of the bus bar 62b to ensure that the bus bar 62b is properly assembled into the insulator 60. The diametric groove 104 further includes a plurality of lands 122 that can support the bus bar 62b.

The insulator 60 further includes a first plurality of diametric walls 123 provided between the diametric groove 102 and the diametric groove 104, and a second plurality of diametric walls 124 provided between the diametric grooves 102, 103. A cylindrical wall 126 is provided at the center of the insulator 60. Each of the first plurality of walls 123 and each of the second plurality of walls 124 is discontinuous along respective diameters. In this manner, each of the walls 123, 124 of the plurality of walls is provided as a wall segment.

The insulator 60 is made from an electrically non-conductive material. Exemplar materials include, but are not limited to, plastics, thermoplastics, rubber, and/or electrically non-conductive composite materials. The insulator 60 can be manufactured using various manufacturing methods. Exemplar manufacturing methods include, but are not limited to, stereolithography, injection molding, blow molding, thermoforming, transfer molding, compression molding, and extrusion.

Referring again to FIG. 2A, the walls 123 are disposed between the bus bar 62a and the bus bar 62b in the regions 78. In this manner, the walls 123 inhibit arcing between the bus bar 62a and the bus bar 62b. The walls 124 are disposed between the bus bar 62a and the bus bar 62c in the regions 72. In this manner, the walls 124 inhibit arcing between the bus bar 62a and the bus bar 62c. In the exemplar arrangement of FIG. 2A, no walls are provided between the bus bar 62a and the bus bar 62b in the regions 80, and no walls are provided between the bus bar 62a and the bus bar 62c in the regions 74. In the regions 74, 80, the radial gaps are of a sufficient distance that arcing is inhibited for the anticipated voltage and current communicated through the bus bars, and insulator walls are not necessary. The absence of insulator walls in these regions enable the bus bars 62a, 62b, 62c to be assembled into the insulator 60, and reduces the amount of material required to manufacture the insulator 60, thereby also reducing the weight and cost of the insulator 60. The absence of insulator walls in these regions also enables air to flow more freely through the bus bar module 16, thereby extracting heat from the bus bar module 16.

Referring now to FIGS. 4A-4C, and as discussed above, the bus bar 62c includes the main body 64c and the plurality of arms 66c. A bore 130c is provided at the distal end of and through each of the arms 66c. The bore 130c enables a fastener (not shown) to be received for securing the bus bar module 16 within the electric machine, and for providing electrical communication between the bus bar 62c and the stator modules. For example, each fastener can extend into a corresponding opening of the stator modules, and provide at least a portion of an electrical path between the bus bar 62c and the respective stator segments. The arms 66c are generally L-shaped, extend radially outward and include a thickness t₁. The arms 66c are equidistantly spaced from one another in the radial direction by an angle θ. In the exemplar arrangement provided herein, θ is equal to 90°.

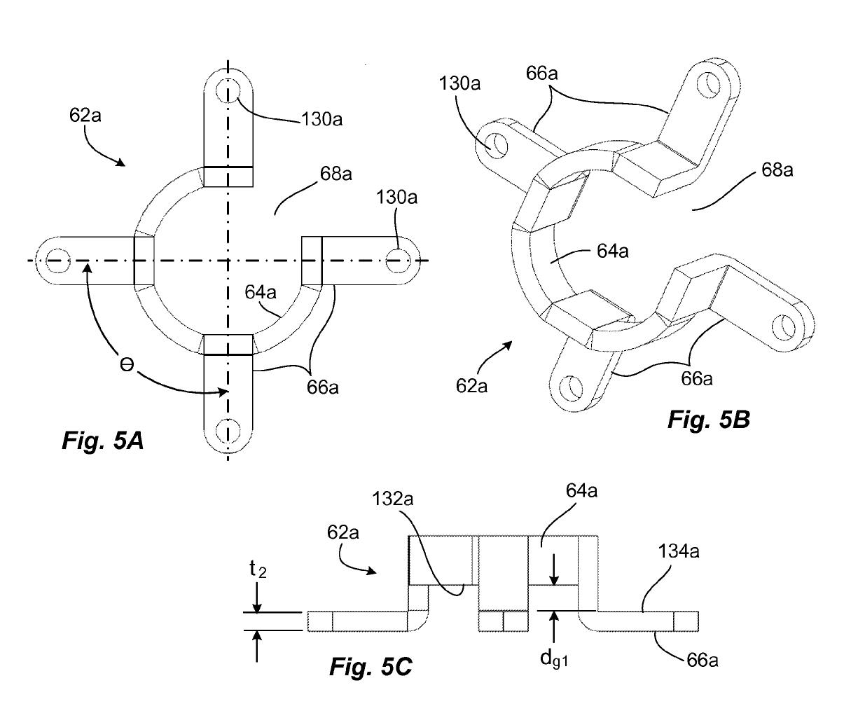

Referring now to FIGS. 5A-5C, and as discussed above, the bus bar 62a includes the main body 64a and the plurality of arms 66a. A bore 130a is provided at the distal end of and through each of the arms 66a. The bore 130a enables a fastener (not shown) to be received for securing the bus bar module 16 within the electric machine, and for providing electrical communication between the bus bar 62a and the stator modules. For example, each fastener can extend into a corresponding opening of the stator modules, and provide at least a portion of an electrical path between the bus bar 62a and the respective stator segments. The arms 66a are generally L-shaped, extend radially outward, and include a thickness t₂. In one arrangement, t₁ is equal to t₂. A base of the main body 132a is offset from a top plane 134a of the arms 66a by a distance d_{g1}. In this manner, the distance d_{g1} defines a gap between the main body 64a of the bus bar and the nested arms 66c of the bus bar 62c extending thereunder. The distance d_{g1} is sufficient to inhibit arcing between the bus bar 62a and the bus bar 62c. The arms 66a are equidistantly spaced from one another in the radial direction by an angle θ. In the exemplar arrangement provided herein, θ is equal to 90°.

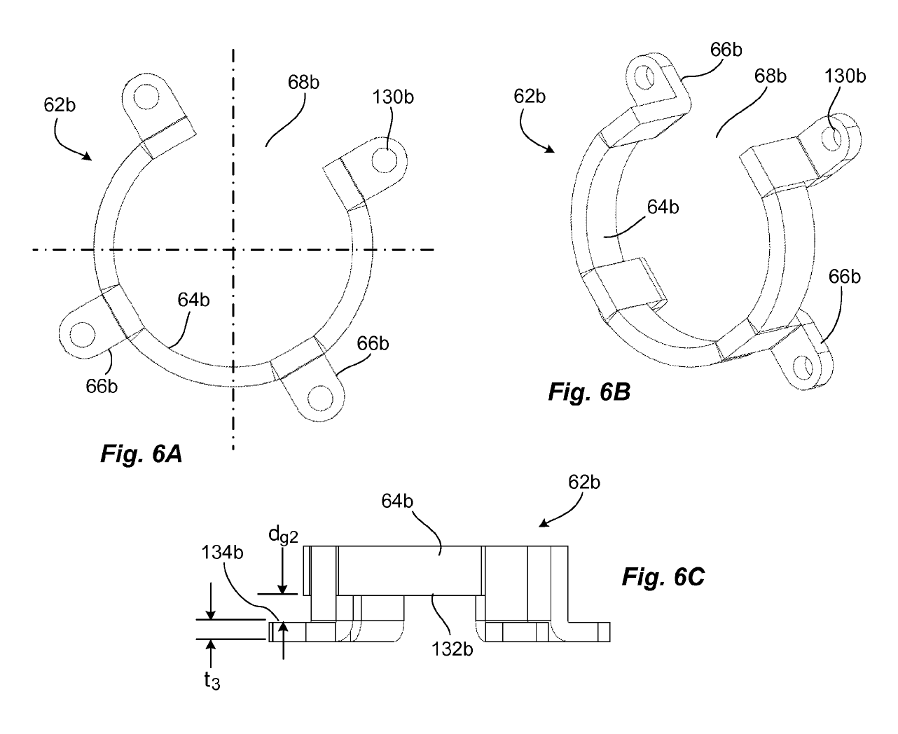

Referring now to FIGS. 6A-6C, and as discussed above, the bus bar 62b includes the main body 64b and the plurality of arms 66b. A bore 130b is provided at the distal end of and through each of the arms 66b. The bore 130b enables a fastener (not shown) to be received for securing the bus bar module 16 within the electric machine, and for providing electrical communication between the bus bar 62b and the stator modules. For example, each fastener can extend into a corresponding opening of the stator modules, and provide at least a portion of an electrical path between the bus bar 62b and the respective stator segments. The arms 66b are generally L-shaped, extend radially outward, and include a thickness t₃. In one arrangement, t₁, t₂, and t₃ are equal. A base 132b of the main body 64b is offset from a top plane 134b of the arms 66b by a distance d_{g2}. In this manner, the distance d_{g2} defines a gap between the main body 64b of the bus bar and the nested arms 66a, 66c of the bus bars 62a, 62c extending thereunder. The distance d_{g2} is sufficient to inhibit arcing between the bus bar 62b and the bus bars 62a, 62c. The arms 66b are equidistantly spaced from one another in the radial direction by an angle θ. In the exemplar arrangement provided herein, θ is equal to 90°.

Referring again to FIG. 1, the exemplar electric machine 10 includes a stator segment to magnet ratio that enables the same stator segment 42a, 42b, 42c of each stator module 40 to appropriately align with the rotor assembly 12. More specifically, when a stator segment 42a, 42b, 42c of a particular stator module 40 is properly aligned with the rotor assembly 12 for the currently charged phase, the corresponding stator segment 42a, 42b, 42c of the remaining stator modules 40 are also properly aligned with the rotor assembly 12. In FIG. 1, for example, the stator segments 42c of each of the stator modules 40 are all properly aligned with the magnets of the rotor assembly 12 for the illustrated rotor assembly position relative to the stator assembly 14.

During operation in a motor mode, power is provided to the stator segments 42a, 42b, 42c with the stator modules 40 through the bus bar module 16. As the electric machine 10 operates, heat is generated within the stator modules 40, which heat reduces operating efficiency. The bus bars 62a, 62b, 62c function as a heat sink to draw heat from the stator module 40, thereby increasing the operating efficiency of the electric machine. More specifically, the thermally conductive bus bars 62a, 62b, 62c are in heat transfer communication with the stator segments 42a, 42b, 42c through the fasteners, for example. As discussed above, the bus bars 62a, 62b, 62c are exposed and do not include a thermally insulating coating. In this manner, heat can dissipate to the air surrounding the bus bars 62a, 62b, 62c. As also discussed above, air is free to flow through the radial and diametric grooves of the insulator 60. In this manner, the heat dissipation of the bus bars 62a, 62b, 62c can be improved.

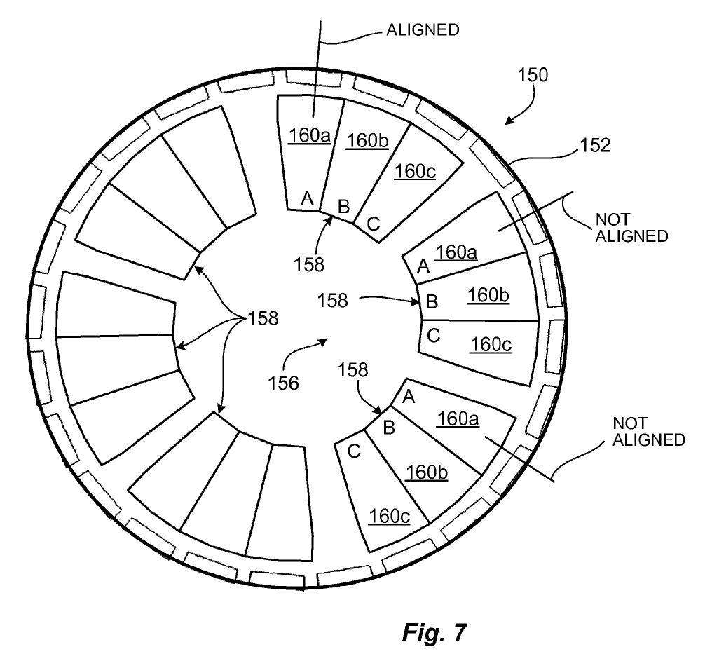

Efforts to optimize the stator segment to magnet ratio to maximize the winding density within the stator assembly 14 can result in difficulty in aligning the stator segments and rotor assembly for the individually charged phase. With particular reference to FIG. 7, an exemplar electric machine 150 is illustrated and includes misaligned stator segments with respect to a rotor assembly 152. More specifically, the electric machine 150 includes the rotor assembly 152, a stator assembly 156 having a plurality of identical stator modules 158. Each of the stator modules 158 includes a plurality of stator segments 160a, 160b, 160c.

With the given rotor position of FIG. 7, a common stator segment is not properly aligned with a respective magnet pair. Consequently, proper operation of the electric machine 150 is inhibited. More specifically, although the stator segment 160a, in a first position of the uppermost stator module 158 (the stator module 158 at approximately the 1 o'clock position), is properly aligned with its respective magnet pair, the same stator segments 160a, in the first position of other stator modules 158 (e.g., the stator modules 158 at approximately the 3 o'clock and 5 o'clock positions), are out of proper alignment with the respective magnet pairs. In order for the stator segments of the stator modules to properly align, the stator modules would be required to be custom made for a particular radial position within the electric machine. Consequently, identical stator modules could not be implemented, increasing cost and complexity of the electric machine.

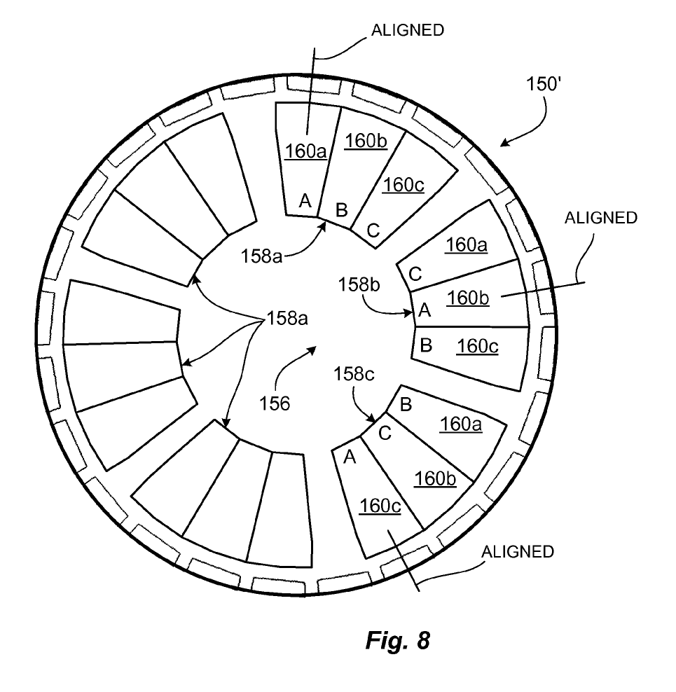

Referring now to FIG. 8, the present disclosure provides a phase-shift arrangement, in which identical stator modules can be implemented in the stator assembly. More specifically, FIG. 8 illustrates the electric machine 150′ including the rotor assembly 152, and the stator assembly 156. The stator assembly 156 includes a plurality of identical stator modules 158a, 158b, 158c. The stator modules 158a, 158b, 158c are identical and can be interchanged with one another, or replaced, without adversely affecting operation of the electric machine 150′. Each of the stator modules 158 includes a plurality of stator segments 160a, 60b, 160c.

In accordance with the phase-shift arrangement of the present disclosure, an arbitrary phase relationship for the electrical connections in an N-phase electrical machine is provided. The stator segments 160a, 160b, 160c are electrically connected to the controller to shift the phases across the stator segments. More specifically, the stator module 158a is electrically connected such that the stator segment 160a, in the first position, corresponds to a first phase (Phase A), the stator segment 160b, in the second position, corresponds to a second phase (Phase B), and the stator segment 160c, in the third position, corresponds to a third phase (Phase C). The stator module 158b, however, is electrically connected such that the stator segment 160a, in the first position, corresponds to the third phase (Phase C), the stator segment 160b, in the second position, corresponds to the first phase (Phase A), and the stator segment 60c, in the third position, corresponds to the second phase (Phase B).

The stator module 158c is electrically connected such that the stator segment 160a, in the first position, corresponds to the second phase (Phase B), the stator segment 160b, in the second position, corresponds to the third phase (Phase C), and the stator segment 160c, in the third position, corresponds to the first phase (Phase A). This shifting pattern is repeated about the remainder of the stator assembly 156. In this manner, the N-phases of the electric machine 150′ (in this case N is equal to 3) are electrically shifted as between adjacent stator modules 158a, 158b, 158c. Consequently, identical stator modules can be implemented without adversely affecting operation of the electric machine.

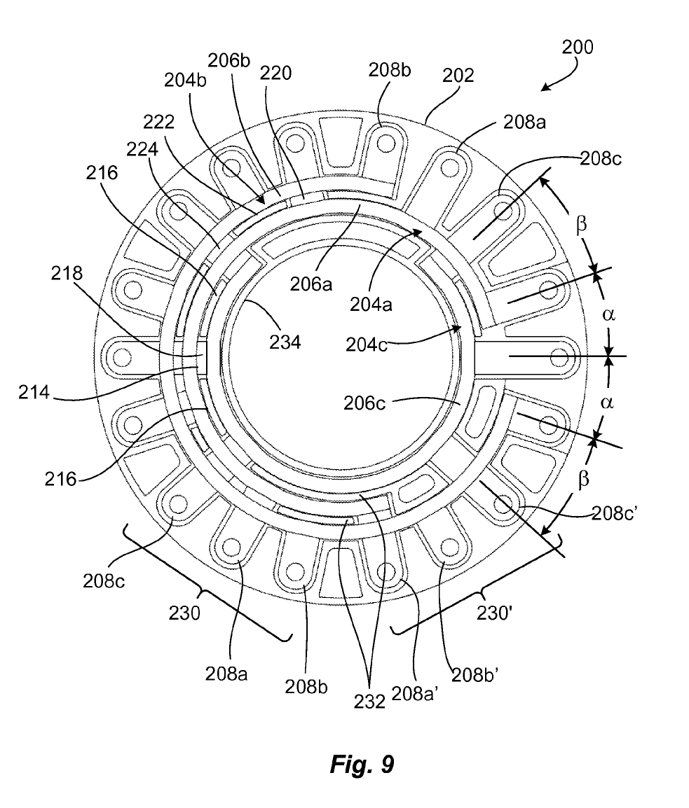

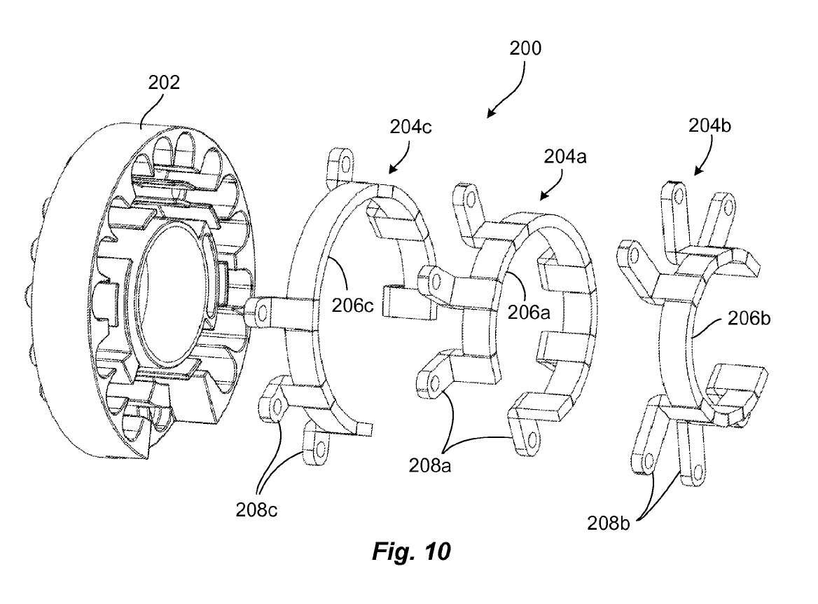

Referring now to FIGS. 9 and 10, a bus bar module 200 is illustrated, which can be implemented to achieve the phase-shift arrangement discussed above. The bus bar module 200 includes an insulator 202, a bus bar 204a, a bus bar 204b, and a bus bar 204c. Each of the bus bars 204a, 204b, 204c corresponds to a phase of a corresponding electric machine (e.g., electric machine 50 of FIG. 8). In the exemplar arrangement, the bus bar 204b can correspond to a first phase (Phase A), the bus bar 204a can correspond to a second phase (Phase B), and the bus bar 204c can correspond to a third phase (Phase C). The bus bars 204a, 204b, 204c are concentrically arranged relative to one another, and are nested within the insulator 202.

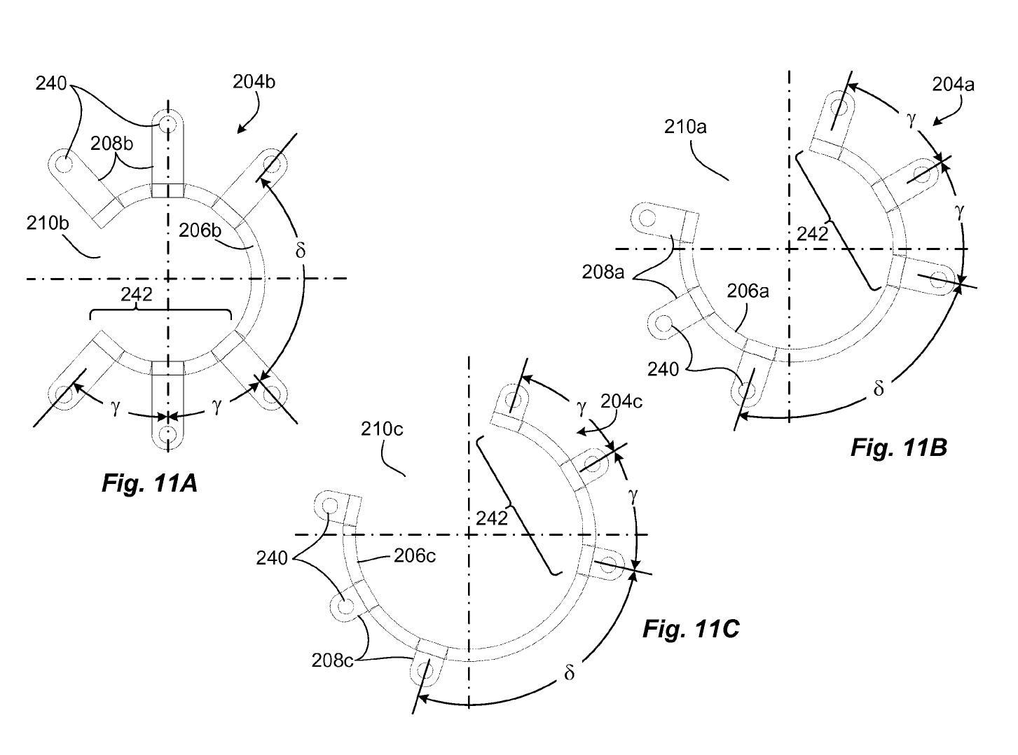

Each of the bus bars 204a, 204b, 204c includes a generally ring-shaped main body and a plurality of radially extending arms. More specifically, the bus bar 204a includes a main body 206a and a plurality of arms 208a, the bus bar 204b includes a main body 206a and a plurality of arms 208a, and the bus bar 204c includes a main body 206c and a plurality of arms 208c. In the exemplar arrangement of FIGS. 9 and 10, the main body 206a, 206b, 206c of each bus bar 204a, 204b, 204c is generally C-shaped having an opening 210a, 210b, 210c (see FIGS. 11A-11C), and each bus bar 204a, 204b, 204c includes six arms 208a, 208b, 208c, corresponding to a potential of six stator modules of an exemplar electric machine. The bus bars 204a, 204b, 204c each define at least a portion of an electrical path between a controller and the stator modules.

Each of the bus bars 204a, 204b, 204c is made from an electrically and thermally conductive material (e.g., copper, gold, platinum, electrically conductive non-metallic materials, and/or electrically conductive composite materials). Further, each of the bus bars 204a, 204b, 204c is exposed, not having an electrically and/or thermally insulating coating provided therearound. In this manner, each bus bar 204a, 204b, 204c can be manufactured from raw stock of a particular material, without further processing to insulate the bus bar. Each bus bar 204a, 204b, 204c can be manufactured from a single piece of material, or can be manufactured by assembling multiple components. For example, the main body of a bus bar can be provided as a separate component from the arms, and the arms can be secured (e.g., through welding) to the main body. As another example, a portion of each arm can define a portion of the main body, and the arms can be interconnected by a body component disposed therebetween.

The bus bars 204a, 204c are separated by a radial gap 214 having a distance d₁. The distance d₁ varies about the diameter of the radial gap 214 to provide a plurality of regions 216, in which the distance d₁ is at a minimum (d_{1MIN}), and a plurality of regions 218, in which the distance d₁ is at a maximum (d_{1MAX}). The bus bars 204a, 204b are separated by a radial gap 220 having a distance d₂. The distance d₂ varies about the diameter of the radial gap 220 to provide a plurality of regions 222, in which the distance d₂ is at a minimum (d_{2MIN}), and a plurality of regions 224, in which the distance d₂ is at a maximum (d_{2MAX}).

The bus bars 204a, 204b, 204c are assembled into the insulator 200, discussed in further detail below. The bus bar 204c is initially assembled into the insulator 200, and the bus bar 204a is subsequently assembled into the insulator 200 to be concentric with the bus bar 204c. The arms 208a, 208c of the bus bars 204a, 204c lie in a common plane, and the arms 208c of the bus bar 204c extend below the main body 206a of the bus bar 204a. In this manner, the bus bar 204c is nested within the bus bar 204a. The bus bar 204b is subsequently assembled into the insulator 200 to be concentric with the bus bars 204a, 204c. The arms 208a, 208b, 208c of the bus bars 204a, 204b, 204c lie in a common plane, and the arms 208a, 208c of the bus bars 204a, 204c extend below the main body 206b of the bus bar 204b. In this manner, the bus bars 204a, 204c are nested within the bus bar 204b.

The arms of the bus bars define a plurality of sets of arms 230. In the exemplar arrangement of FIG. 9, six sets of arms are provided, corresponding to a potential of six stator modules to be included with an associated the electric machine. Each set of arms 230 includes three arms, corresponding to the exemplar phases of the electric machine. Adjacent arms 208a, 208c; 208b, 208c in a set of arms 230 define a first angle α. The sets of the plurality of sets of arms 230 are offset from one another by a second angle β, which is different than (i.e., not equal to) the first angle α. In the illustrated arrangement, α is less than β. However, other arrangements are contemplated, in which a is greater than β. Because α and β are not equal, improper connection of the stator modules to the bus bar module 200 is prohibited, as discussed herein.

The insulator 202 includes a plurality of radially extending grooves, and a plurality of diametric grooves crossing the radial grooves, as similarly described above with respect to the insulator 202. The radial grooves receive and accommodate the arms 208a, 208b, 208c of the bus bars 204a, 204b, 204c, and the diametric grooves receive and accommodate the main bodies 206a, 206b, 206c of the bus bars 204a, 204b, 204c. The diametric grooves include stops defined by geometric features of the insulator 202 to provide for indexing of the bus bars 204a, 204b, 204c as they are assembled into their respective diametric grooves. More specifically, the geometric features extend into the respective openings 210a, 210, 210c of the bus bars 204a, 204b, 204c to ensure that the bus bars 204a, 204b, 204c are properly assembled into the insulator 202. The diametric grooves can further include lands that can be used to support the bus bars 204a, 204b, 204c.

The insulator 202 further includes a diametric walls 232 provided between the bus bars 204a, 204b, 204c. Each of the walls 232 is discontinuous along respective diameters. In this manner, each of the walls 232 is provided as a wall segment. A cylindrical wall 234 is provided at the center of the insulator 202.

The insulator 202 is made from an electrically non-conductive material. Exemplar materials include, but are not limited to, plastics, thermoplastics, rubber, and/or electrically non-conductive composite materials. The insulator 202 can be manufactured using various manufacturing methods. Exemplar manufacturing methods include, but are not limited to, stereolithography, injection molding, blow molding, thermoforming, transfer molding, compression molding, and extrusion.

Referring again to FIG. 9, the walls 232 are disposed between the bus bars 204a, 204b, 204c along the regions 216, 222. In this manner, the walls 232 inhibit arcing between the bus bars 204a, 204b, 204c. In the exemplar arrangement of FIG. 9, no walls are provided between the bus bars 204a, 204b, 204c in the regions 218, 224. In the regions 218, 224, the radial gaps 214, 220 are of a sufficient distance that arcing is inhibited for the anticipated voltage and current communicated through the bus bars 204a, 204b, 204c, and insulator walls are not necessary. The absence of insulator walls in these regions enables the bus bars 204a, 204b, 204c to be assembled into the insulator 202, and reduces the amount of material required to manufacture the insulator 202, thereby also reducing the weight and cost of the insulator 202. The absence of insulator walls in these regions also enables air to flow more freely through the bus bar module 200, thereby extracting heat from the bus bar module, as discussed in further detail below.

Referring now to FIGS. 11A-11C, and as discussed above, each bus bar 204a, 204b, 204c includes the main body 206a, 206b, 206c and the plurality of arms 208a, 208b, 208c. A bore 240 is provided at the distal end of and through each of the arms 208a, 208b, 208c. The bores 240 enable fasteners (not shown) to be received for securing the bus bar module 200 within an electric machine, and for providing electrical communication between the bus bars 204a, 204b, 204c and respective stator modules. For example, each fastener can extend into a corresponding opening of respective stator modules, and provide at least a portion of an electrical path between the bus bars 204a, 204b, 204c and the respective stator segments. The arms 208a, 208b, 208c are generally L-shaped, extend radially outward and include a thickness t_{ARM}. The arms 208a, 208b, 208c of each of the respective bus bars 204a, 204b, 204c are provided in sets 242. Adjacent arms in a set 242 are offset from one another by an angle γ. The sets 242 are offset from one another by another angle δ.

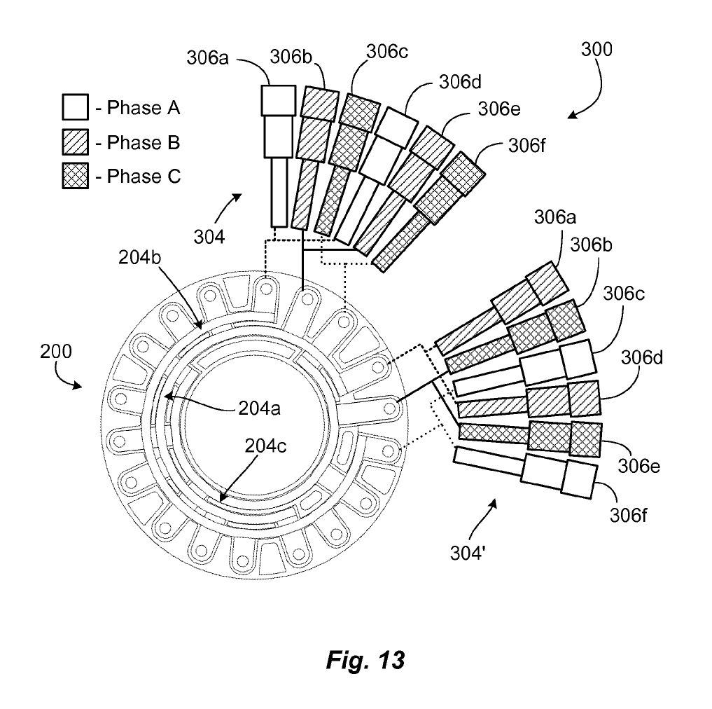

Referring again to FIG. 9, the above-described geometry of the bus bars 204a, 204b, 204c implicitly provides the phase-shift arrangement discussed above. More specifically, and as highlighted in further detail below with reference to FIG. 13, the arms of a particular bus bar correspond to various radial positions within the sets 230. For example, in one set 230, an arm 208b is in a first position, an arm 208a is in a second position, and an arm 208c is in a third position. In another set 230′, adjacent to the set 230, an arm 208c′ is in the first position, an arm 208b′ is in the second position, and an arm 208a′ is in the third position. Accordingly, the arms of the respective bus bars shift positions across respective sets, thereby shifting a corresponding phase from set to set.

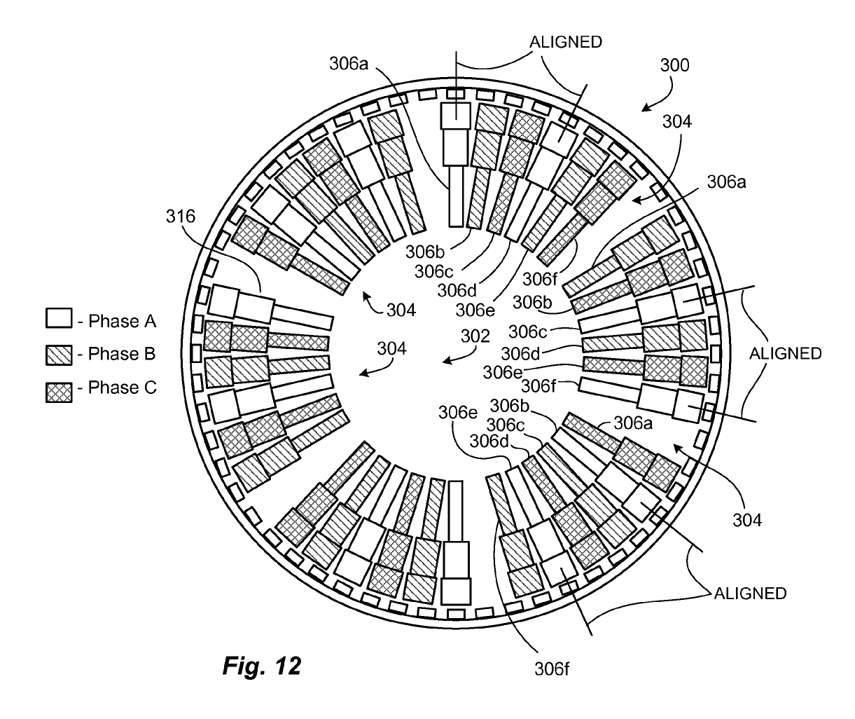

Referring now to FIG. 12, portions of another exemplar electric machine 300 are schematically illustrated. The electric machine 300 includes a stator assembly 302 having a plurality of identical stator modules 304. Each stator module 304 includes a plurality of stator segments 306a, 306b, 306c, 306d, 306e, 306f. The stator segments 306a, 306b, 306c, 306d, 306e, 306f correspond to particular phases of the electric machine, and are provided in sets including a plurality of stator segments corresponding to a common phase.

In the exemplar arrangement of FIG. 12, each sets includes two stator segments separated from each other by intermediate stator segments. For example, and with respect to the upper-most stator module 304 (e.g., at approximately the 1 o'clock position), one set includes stator segments 306a, 306d corresponding to a first phase (Phase A), another set includes stator segments 306b, 306e corresponding to a second phase (Phase B), and still another set includes stator segments 306c, 306f corresponding to a third phase (Phase C). With respect to the right-most stator module 304 (e.g., at approximately the 3 o'clock position), the set of stator segments 306a, 306d corresponds to the second phase (Phase B), set of stator segments 306b, 306e corresponds to the third phase (Phase C), and the set of stator segments 306c, 306f corresponds to the first phase (Phase C). With respect to the lower right stator module 304 (e.g., at approximately the 5 o'clock position), the set of stator segments 306a, 306d corresponds to the third phase (Phase C), set of stator segments 306b, 306e corresponds to the first phase (Phase A), and the set of stator segments 306c, 306f corresponds to the second phase (Phase B).

In this manner, the phases are shifted by one stator segment as between adjacent, identical stator modules 304. Consequently, for a given rotor position, stator segments corresponding to a common phase can be appropriately aligned with corresponding rotor poles. In the exemplar rotor position of FIG. 12, the stator segments corresponding to the first phase (Phase A) are all appropriately aligned across each of the stator modules 304.

Referring now to FIG. 13, the bus bar module 200 can be implemented with the exemplar electric machine 300, a portion of which is illustrated. In the exemplar arrangement illustrated in FIG. 13, the bus bar 204b is in electrical communication with the stator segments 306a, 306d, the bus bar 204a is in electrical communication with the stator segments 306b, 306e, and the bus bar 204c is in electrical communication with the stator segments 306c, 306f for the stator module 304. In the case of the adjacent stator module 304′, the relationship between the stator segments and the bus bars is shifted. More specifically, the bus bar 204a is in electrical communication with the stator segments 306a, 306d, the bus bar 204c is in electrical communication with the stator segments 306b, 306e, and the bus bar 204b is in electrical communication with the stator segments 306c, 306f. Although not illustrated, the relationship between the stator segments and the bus bars is again shifted for the next adjacent stator module. More specifically, the bus bar 204c is in electrical communication with the stator segments 306a, 306d, the bus bar 204b is in electrical communication with the stator segments 306b, 306e, and the bus bar 204a is in electrical communication with the stator segments 306c, 306f for the next adjacent stator module (not shown).

A number of implementations of the present disclosure have been described. Nevertheless, it will be understood that various modifications may be made without departing from the spirit and scope of the present disclosure. Accordingly, other implementations are within the scope of the following claims.

1. An electric machine, comprising:
a rotor assembly;
a stator assembly comprising a plurality of stator modules, each stator comprising multiple, independently energizeable stator segments, each segment having a corresponding electrical connecting point; and
a plurality of bus bars connected to the electrical connecting points of the stator assembly, each bus bar corresponding to a different phase of the machine and electrically connecting segments of multiple stator modules;
wherein the stator modules and their electrical connecting points are arranged such that spacing between adjacent connecting points within each stator module differs from spacing between adjacent connecting points of different modules.

2. The electric machine of claim 1, wherein the stator assembly is disposed within the rotor assembly, the stator assembly and rotor assembly defining therebetween an active magnetic radial gap.

3. The electric machine of claim 1, wherein the bus bars are provided in a nested arrangement.

4. The electric machine of claim 1, wherein arms of one of the bus bars extend transverse to another of the bus bars.

5. The electric machine of claim 1, wherein at least one of the bus bars includes a segment that passes over, and is spaced from, arms of at least another of the bus bars.

6. The electric machine of claim 5, wherein the segment is spaced from the arms a distance sufficient to inhibit arcing.

7. The electric machine of claim 1, wherein each bus bar includes a plurality of generally L-shaped arms having a first segment and a second segment perpendicular to the first segment.

8. The electric machine of claim 1, wherein each bus bar includes a plurality of arms, each arm defining a bore configured to receive a fastener to secure the arm to a respective stator module of the electric machine.

9. The electric machine of claim 1, wherein the bus bars are concentrically arranged relative to one another.

10. The electric machine of claim 1, wherein each of the bus bars includes arms extending radially outward.

11. The electric machine of claim 1, wherein arms of one of the bus bars are longer than arms of another of the bus bars.

12. The electric machine of claim 1, wherein each of the bus bars is electrically conductive.

13. The electric machine of claim 1, wherein a radial distance between adjacent bus bars varies.

14. The electric machine of claim 13, further comprising an insulator segment that is disposed between adjacent bus bars in a region, within which region the radial distance is at a minimum.

15. The electric machine of claim 14, wherein the insulator segment is discontinuous about a diameter.

16. The electric machine of claim 13, wherein an insulator segment is absent from between adjacent bus bars in a region, within which region the radial distance is at a maximum.

17. The electric machine of claim 1, further comprising an insulator that receives each of the bus bars.

18. The electric machine of claim 17, wherein the insulator includes a plurality of radial grooves for receiving each of the arms of the bus bars.

19. The electric machine of claim 18, wherein the radial grooves define a plurality of sets of grooves, adjacent grooves in a set of grooves defining an angular spacing, and the sets of the plurality of sets of grooves being offset from one another, different angular spacing.

20. The electric machine of claim 17, wherein the insulator is electrically non-conductive.

21. The electric machine of claim 17, wherein the insulator comprises a plurality of lands that can support one or more of the bus bars.

22. The electric machine of claim 17, wherein the insulator comprises a plurality of bores, through which a fastener can pass to secure a bus bar to a respective stator module.

23. The electric machine of claim 17, wherein the insulator comprises a plurality of protrusions for indexing the bus bar assembly relative within the electric machine.

24. The electric machine of claim 1, wherein the electric machine is a three-phase electric machine, and there are three bus bars.

25. The electric machine of claim 1, wherein the electric machine comprises four stator modules.

26. The electric machine of claim 1, wherein the electric machine comprises six stator modules.

27. The electric machine of claim 1, wherein the stator modules are individually removable, and wherein the machine is operable with multiple configurations of stator modules.

28. The electric machine of claim 1, wherein each of the plurality of stator segments is an independently energizable electromagnetic assembly, and comprises a one-piece magnetic core defining two stator poles located at opposite ends of the one-piece magnetic core.

29. The electric machine of claim 28, wherein the one-piece magnetic core is formed from thin film soft magnetic material.

30. The electric machine of claim 29, wherein the one-piece magnetic core is formed from a powdered magnetic material.

31. The electric machine of claim 1, wherein multiple stator segments within a stator module correspond to a common phase.
